(19) United States
(12) Patent Application Publication
(10) Pub. No.: US 2006/0206867 A1
(43) Pub. Date: Sep. 14, 2006

(54) Test followup issue tracking

(75) Inventors: Hans R. Parsons, Redmond, WA (US); Peter M. Spillman, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/077,747

(22) Filed: Mar. 11, 2005

(51) Int. Cl. G06F 9/44

(52) U.S. Cl. 717/124

(57) ABSTRACT

A system for identifying testing needs in software development is disclosed. The system comprises an identification module that associates an attribute of a software component with an identifier that designates a need to test the software component. A tracking module is operatively connected to the identification module to indicate the existence of an assigned test for the software component and allow a user to assign a test for the software component if no test is assigned to the software component. A method for using the system is also provided.

### TECHNICAL FIELD

The present invention relates generally to software development, and more particularly to systems and methods for testing software.

### BACKGROUND

Over the years, the task of creating software has evolved from a task that was merely ancillary to creating computing devices to an engineering discipline in and of itself. Modern computer software typically comprises thousands of modules and often includes millions of lines of source code. Partly because of their sheer size, modern software packages are usually extremely complex.

Software engineering is in large part concerned with managing the complexities of all aspects of software creation. As a result, a variety of tools have been created to assist software developers. Such tools include integrated development environments and code versioning systems. Such tools provide convenient systems to create and edit source code. Among the functions typically provided by these development tools is the ability to monitor and manage development efforts, including managing edits as separate versions of source code.

Software development includes the needs to identify errors and ensure that those errors are corrected. Errors may be introduced into software by various means including both human error and as the unintentional consequence of corrections of other errors. Because modern software is generally constructed as a set of cooperating modules, changes to one module may cause another module to malfunction. Testing is thus a complex and integral part of software development that ideally is performed on every module. Testing efforts, like other software development efforts, must be appropriately managed. Therefore, there is a need for tools to assist in the management of testing efforts.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In accordance with one aspect of the invention, a system for managing testing of software components is provided. The system provides a management platform that allows a user to define and query metadata associated with testing procedures designed to identify software errors so that those errors not only can be corrected but also so that appropriate follow-up testing can be tracked and performed to ensure that the identified software errors have in fact been corrected.

Relating to another aspect of the invention, systems and methods for tracking testing efforts during software development are provided. A testing life cycle is created and tracked using aspects of the disclosed invention so that issues that require but lack testing work can be readily identified and addressed. These disclosed systems and methods allow software testers to more closely coordinate efforts with software developers during creation of a software product.

In accordance with still another aspect of the invention, the disclosed systems and methods provide means for software development teams to communicate testing and revision information regarding specified components of a software product under development or revision. Metadata regarding testing efforts is supplied for each code issue requiring testing. Such metadata can be used to query testing status and to identify testing needs. This metadata can also be used to prioritize and schedule testing efforts as part of overall management of software development efforts.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the subject invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a system block diagram of a test follow-up issue tracking system in accordance with an aspect of the disclosed invention.

FIG. 2 is a system block diagram of a tracking component.

FIG. 3 is a system block diagram of a software development, versioning, testing, and tracking system in accordance with an aspect of the subject invention.

FIG. 4 is a diagram of a graphical user interface (GUI) in accordance with yet another aspect of the invention.

FIG. 5 is a flow diagram presenting a general method of managing software component testing in accordance with certain aspects of the disclosed invention.

FIG. 6 is a flow diagram that illustrates a software development and testing method in accordance with still another aspect of the invention.

FIG. 7 is a flow diagram that illustrates a test tracking method in accordance with yet another aspect of the invention.

FIG. 8 is a schematic block diagram of a sample-computing environment with which the subject invention can interact.

FIG. 9 is a system block diagram of an exemplary environment for implementing various aspects of the invention.

### DETAILED DESCRIPTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

The subject invention relates to systems and methods to facilitate software development, specifically aspects of software development concerned with managing the testing of software components. For the purposes of this disclosure, and where either appropriate or required by context, the terms source code, source code file, software, software module, component, and software component may be used interchangeably. Each term should not be interpreted as excluding other terms unless specifically stated or clearly required by context.

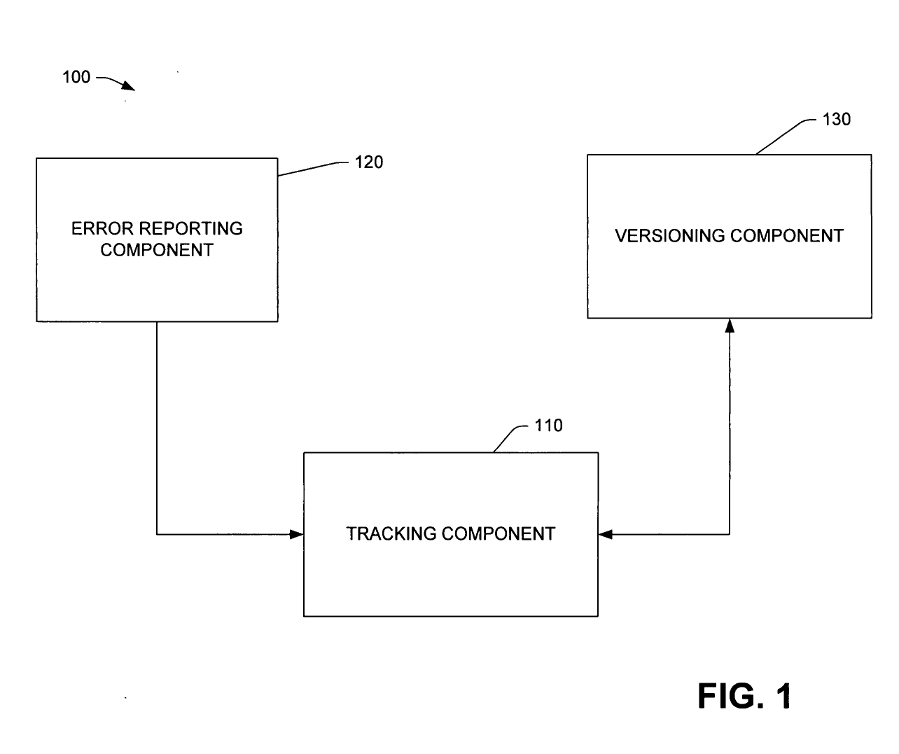

FIG. 1 is a system block diagram of a test follow-up issue tracking system 100 in accordance with an aspect of the disclosed invention. The test follow-up issue tracking system 100 includes a tracking component 110 that is coupled to an error reporting component 120. The tracking component 110 is shown also coupled to a versioning component 130. The versioning component can be a source code versioning system that has been adapted to work with a tracking component or can be a specially designed subsystem of the test follow-up issue tracking system 100.

In operation, the tracking component 110 obtains software error reports from the error reporting component 120. These error reports can be as simple as a flag that indicates that a software module contains an error or as complex as desired including detailed metadata regarding details about a source and description of the error along with testing needs and information. Upon receiving the error report, the tracking component 110 associates the error report with a version of a software component obtained from the versioning component 130. More than one error report can be associated with a software module. Once associated, the tracking component 110 tracks an error report or reports with the corresponding software module so that a user can determine what error reports, if any, are associated with what software modules.

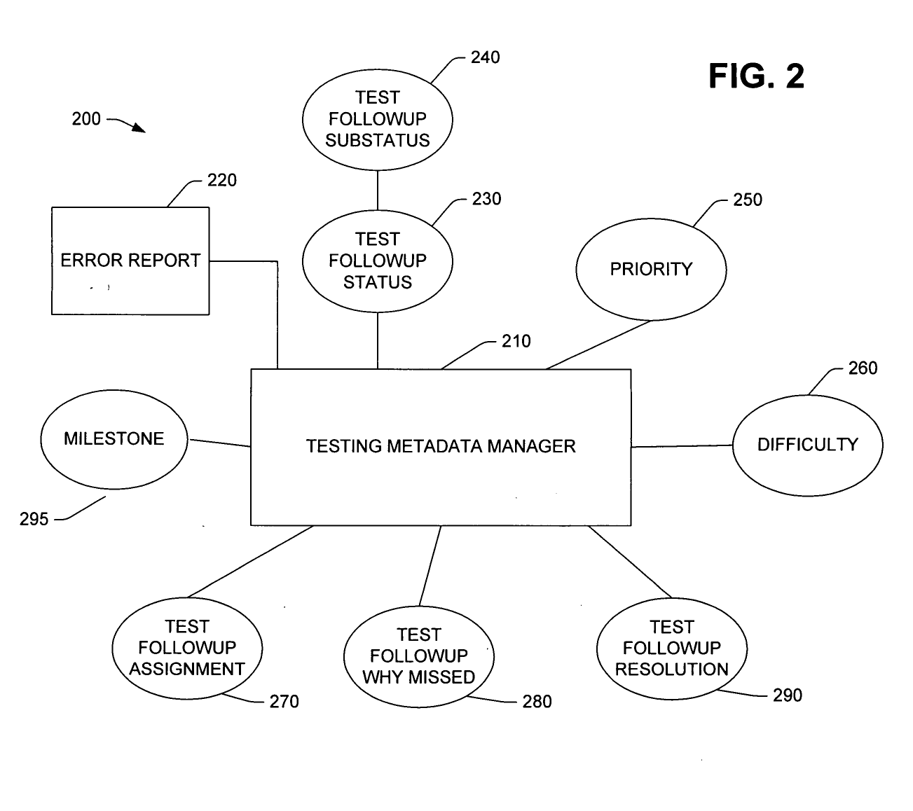

FIG. 2 is a system block diagram of a tracking component 200. The tracking component 200 includes a testing metadata manager 210 that in accordance with another aspect of the invention facilitates the assignment of metadata to an error report 220. Metadata that can be assigned include a test follow-up status 230 and a test follow-up substatus 240. The test follow-up status 230 is a general indicator of whether testing for an associated software module is ongoing. The test follow-up substatus 240 is an indicator giving greater detail about the test follow-up status 230, such as whether testing has yet to begin, has been completed, or whether new tests have to be created to address the error associated with the software module to be tested.

The testing metadata manager 210 can also provide for an assignment of a test priority 250. The test priority 250 is an indicator of relative importance of testing of an associated software module in an overall development scheme. A test difficulty 260 can also be assigned and is an indicator of an estimated amount of effort that will be required to test the associated software module. The test difficulty 260 can also be a proxy for an estimated amount of time or needed skill level to address testing needs for the software module. A test follow-up assignment 270 indicates an identity of a tester to whom responsibility for testing the software module is assigned.

Test follow-up why missed 280 metadata indicates a reason why an issue that resulted in the creation of an error report was missed during previous testing efforts. Such reasons can include an indication that the software module in question is new or a new version, and thus has not been tested previously, or that previous tests that were applied to the software module were not adequate to identify the specific problem identified by the error report. Test follow-up resolution 290 metadata provides information regarding solutions to testing issues identified in the test follow-up why missed 280 metadata. Milestone 295 metadata provides a key to a development timeline that can be used to further manage testing efforts.

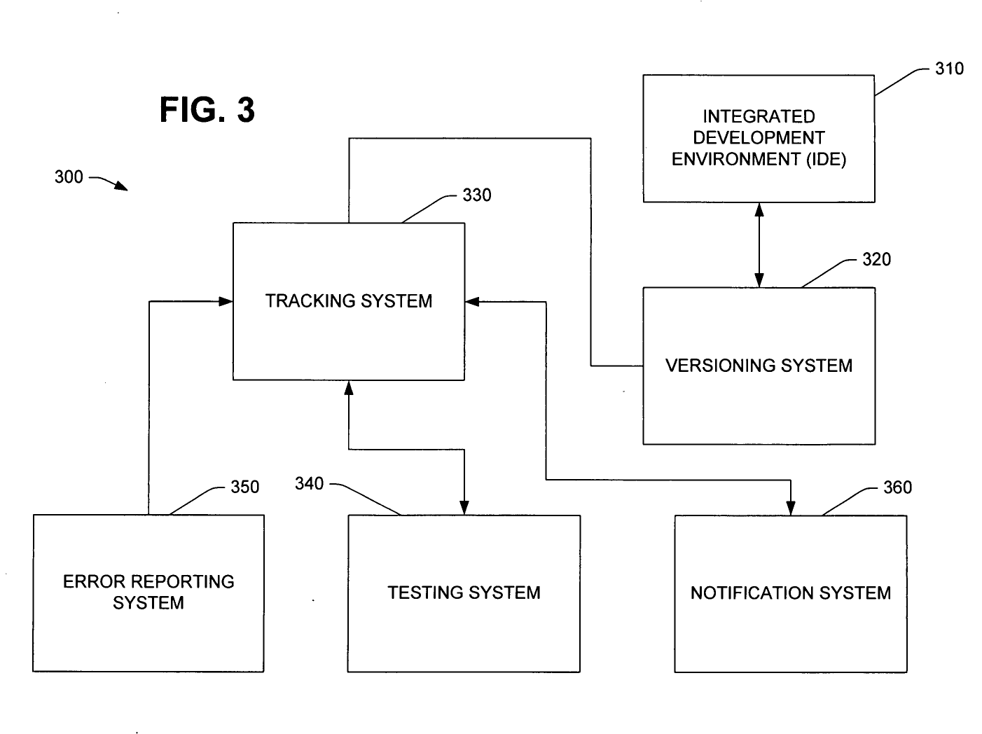

FIG. 3 is a system block diagram of a software development, versioning, testing, and tracking system 300 in accordance with an aspect of the subject invention. An integrated development environment 310 provides a platform upon which source code can be written and compiled into machine-readable instructions. The integrated development environment 310 is coupled to a versioning system 320 that controls access to source code files and provides functions that assist in the management of versions of source code. The versioning system 320 is coupled to a tracking system 330. The tracking system 330 can access information about the source code files of the versioning system 320, including version information. The tracking system 330 is also coupled to a testing system 340. The testing system 340 provides a platform that can be used by testers to create, run, and evaluate automatic or manual tests to be applied to software modules created from source code files.

The tracking system 330 is further connected to an error reporting system 350. The error reporting system 350 is a platform that can be used to create error reports that describe identified errors with software modules. The tracking system can associate information from the versioning system 320 with information from the error reporting system 350 so that reported errors in particular software modules can be more readily managed. A notification system 360 is connected to the tracking system 330 and provides a means by which information related to software development processes can be distributed to participants in a software development project. The notification system can be an electronic mail system, an interface to a calendar or scheduling system, an instant messaging system, or some other appropriate means of transmitting information.

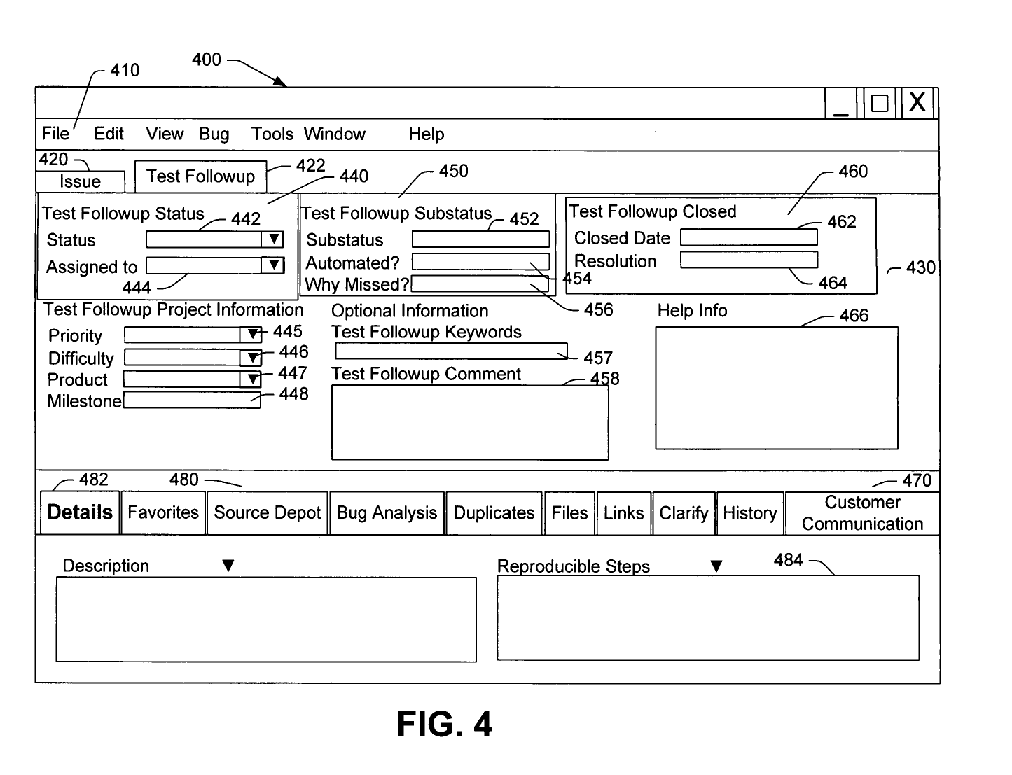

FIG. 4 is a diagram of a graphical user interface (GUI) 400 in accordance with yet another aspect of the invention. The GUI 400 facilitates data entry tasks related to the tracking of software error testing by providing tools such as menus, buttons, tabs, and text fields, among others. A group of menu items 410 includes menus such as a file menu, an edit menu, and a bug menu, among others. In this context, the term bug refers to an error in a software module.

A group of tabs 420 includes an issue tab and a test followup tab that is shown as active. Activation of the test followup tab 422 causes a group of panes to be displayed within an upper window area 430. These panes are generally arranged horizontally with each covering approximately one-third of the space of the upper window area 430 and include a test followup status pane 440, a test followup substatus pane 450, and a test followup closed pane 460.

Within the test followup pane 440 is a status field 442 within which a status indicator may be entered or selected from among choices in a drop-down menu. An assigned to field 444 provides an area within which a name of a tester to whom a test followup task has been assigned. As with the status field 442, an entry within the assigned to field 444 can be made by selecting an item from among items in a list associated with a drop-down menu. It should be recognized that a name of a group or team can be entered in place of, or along with, a name of an individual.

A priority field 445 is an area in which information relating to a priority of test followup efforts can be entered, again, by typing or optionally using a pull-down menu. Information related to testing difficulty can be entered in difficulty field 446. A product field 447 allows for the designation of a product with which a software module is associated. A milestone field 448 allows for entry of a development milestone, such as a date, a build number, or other appropriate identifier that can be used to key test followup information to a development timeline.

The test followup substatus pane 450 includes a substatus field 452 within which more detailed information related to a test status can be entered. An automated field 454 provides an area within which a user can designate whether a test associated with a software module is an automated test or a manual test. A why missed field 456 allows for entry of a designation of whether or why an error in a software component was missed by previous testing. A test followup keywords field 457 provides an area within which terms that ideally are meaningful and searchable descriptors of test followup issues can be entered. A test followup comment area 458 provides an area within which more detailed comments can be entered that ideally identify or explain test followup issues.

The test followup closed pane 460 includes a closed date field 462 that accepts a date upon which a test followup issue was closed. A resolution field 464 accepts a description of a resolution to a testing issue. A help information area 466 is an area within which various user-assistive messages can be displayed.

A lower window area 470 contains a group of tabs 480. A details tab is shown selected, causing a description area 482 and a reproducible steps area 484 to be displayed. The description area 484 provides a place within which a fuller description of testing issues can be entered. The reproducible steps are 484 provides an area within which a description of steps that can be repeated to cause an error can be placed. Other tabs, such as favorites, source depot, bug analysis, duplicates, files, links, clarify, history, and customer communication tabs can be selected to provide access to additional functions such as shortcuts to frequently accessed areas of the system, source code, analyses of errors, links to helpful websites or system locations, use history, and customer communication information, among others.

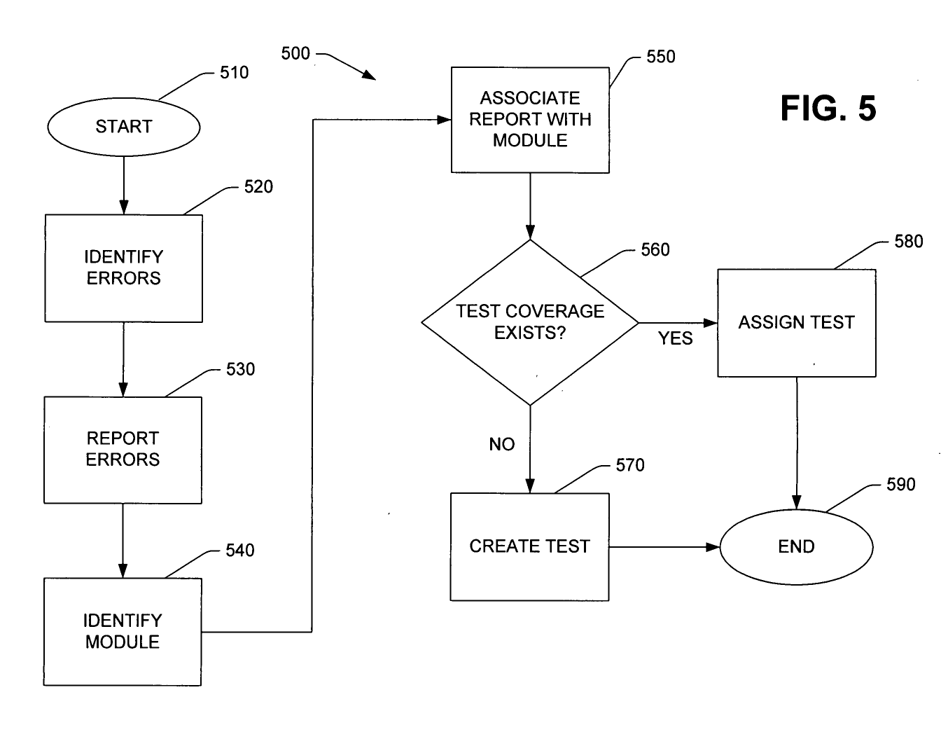

FIGS. 5-7 illustrate exemplary methodologies in accordance with the subject invention. For simplicity of explanation, these methodologies are depicted and described as a series of acts. Those of ordinary skill in the art will understand and appreciate that the subject invention is neither limited by the specific exemplary acts illustrated nor limited by the order of such acts. Skilled artisans will recognize that the described exemplary acts can occur in various orders and/or concurrently, and with other acts not presented and described herein. Furthermore, not all illustrated acts may be required to implement the methodologies in accordance with the subject invention. In addition, those skilled in the art will understand and appreciate that the described exemplary methodologies could alternatively be represented as a series of interrelated states via a state diagram or events.

FIG. 5 is a flow diagram presenting a general method 500 of managing software component testing in accordance with certain aspects of the disclosed invention. The method 500 is preferentially computer-aided or wholly computer-implemented. Performance of the method 500 begins at START block 510 and continues to process block 520 where software errors are identified. Ideally, but not necessarily, identification of software errors includes identification of one or more reproducible steps that a user may perform to cause the identified error to occur. Processing then continues at process block 530 where an error report is created. Typically, an error report is limited to identification or discussion of a single error. Therefore multiple error reports are usually used to identify multiple errors and more than one error report can be associated with a single software component.

The created error report is used to assist in identifying a software module that includes or causes the described error at process block 540. At process block 550, one or more error reports are associated with a software module. Decision block 560 illustrates a determination whether a test for the identified error exists. If that determination is negative, the existence of a test hole is thus indicated and an appropriate test, usually an automatic test but possibly a manual test, is created at process block 570. If the determination made at decision block 560 is positive, at process block 580 a preexisting test is assigned. Processing concludes at END block 590.

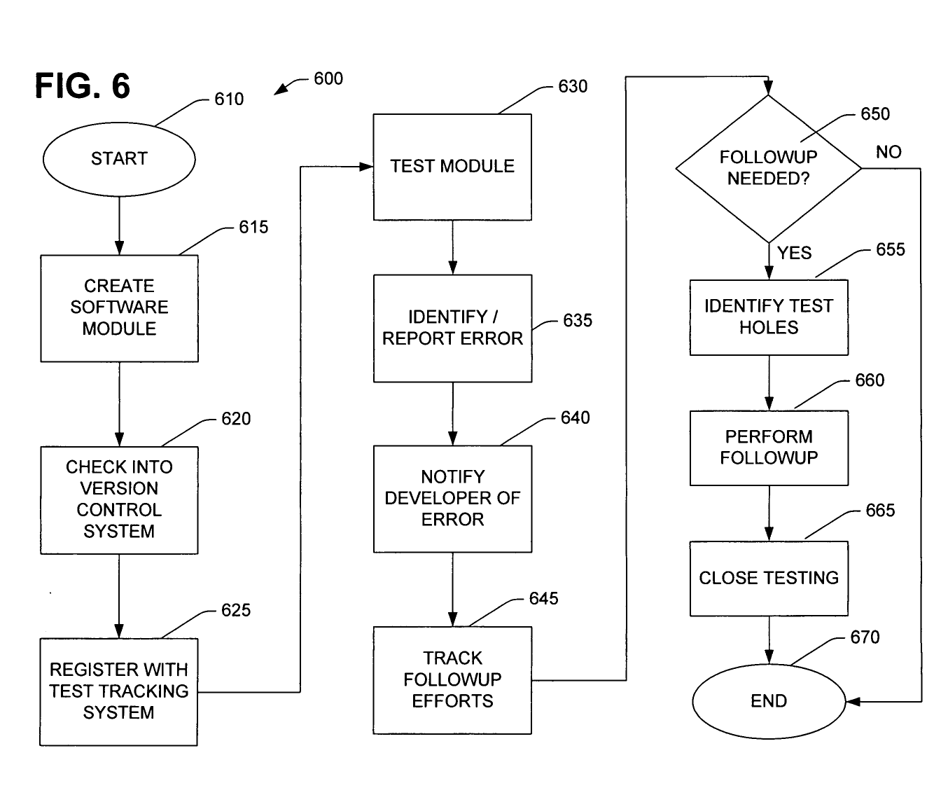

FIG. 6 is a flow diagram that illustrates a software development and testing method 600 in accordance with still another aspect of the invention. Ideally, performance of the software development and testing method 600 is either computer-aided or wholly computer-implemented. Performance of the software development and testing method 600 begins at START block 610 and proceeds to process block 615 where a software developer creates a software module, usually by authoring one or more text files that contain computer source code written in an appropriate programming language. At process block 620, the developer checks source code files into a code versioning system. The checked-in source code is then registered with a test tracking system at process block 625.

At process block 630, the software module is tested, usually by application of predefined automatic or manual test procedures. Any errors are identified and reported at process block 635. At process block 640, the software developer, along with any other appropriate or interested parties such as senior developers, testers, or managers, are notified of the existence of an identified error in the software module. Appropriate followup efforts are defined and tracked at process block 645. A determination is made at decision block 650 whether followup testing and tracking is needed with respect to that software module. If yes, any test holes are identified at process block 655. The term test hole specifically includes errors or functions for which no test has been created. At process block 660 any necessary or desired followup testing is performed. Testing is closed at process block 665 and processing concludes at END block 670. Similarly, if the determination made at decision block 650 indicates that no followup is needed, processing concludes at END block 670.

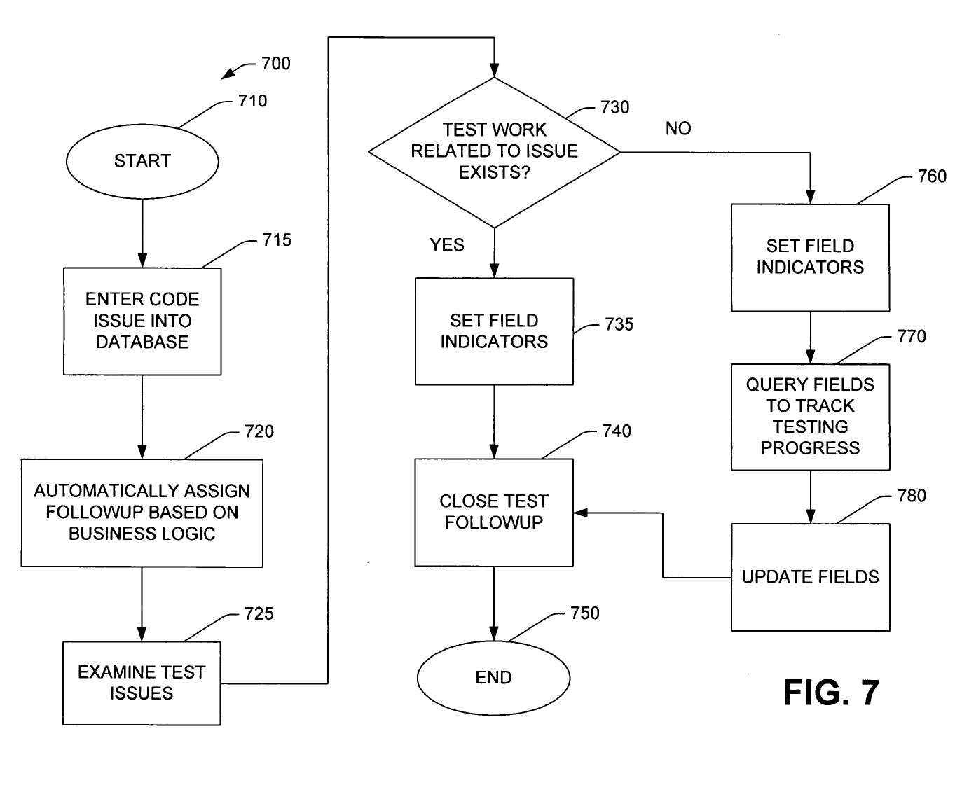

FIG. 7 is a flow diagram that illustrates a test tracking method 700 in accordance with yet another aspect of the invention. Ideally, performance of the test tracking method 700 is either computer-aided or wholly computer-implemented. Performance begins at START block 710 and continues to process block 715 where a code issue is entered into a database. At process block 720, testing followup is automatically assigned in accordance with predefined business rules or logic. Specifically, an assignment to a tester is made, a status indicator is set to active, and a substatus is set to indicate that test followup issues have not yet been examined by a tester. Part of the automatic assignment can also include transmission of an electronic mail or other electronic message to the tester that advises of the existence of test followup items that require attention.

At process block 725 the tester examines assigned test issues. At decision block 730, a determination is made whether test work related to the code issue exists. If it is determined that test coverage exists, appropriate indicators in data fields are set at process block 735. Specifically, the test followup status is set to closed, the substatus is set to work complete, a why missed field is set to indicate that the issue was not missed, and a resolution field is set to indicate that test coverage exists for the code issue. Test followup is then closed at process block 740. Processing concludes at END block 750.

If the determination made at decision block 730 indicates that no test work exists, appropriate field indicators are set at process block 760. Specifically, the test followup substatus is set to automated (or manual) case needed, a priority field is set to indicate a relative priority of adding an appropriate test case, and a difficulty field is set to contain an estimator of the length of time needed to complete test work. Processing continues at process block 770 where a tester queries appropriate fields to tract testing progress. Once testing has been completed, appropriate fields are updated at process block 780. Specifically, the test followup substatus is set to work complete, the why missed field is set to indicate a reason why the code issue was missed in previous testing, and the resolution field is set to indicate that test coverage has been added. Processing then continues at process block 740 where test followup is closed and processing concludes at END block 750.

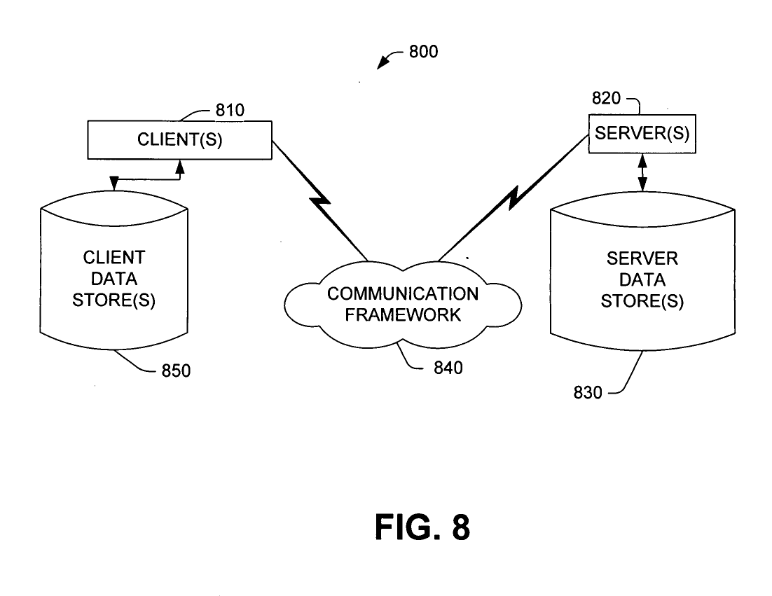

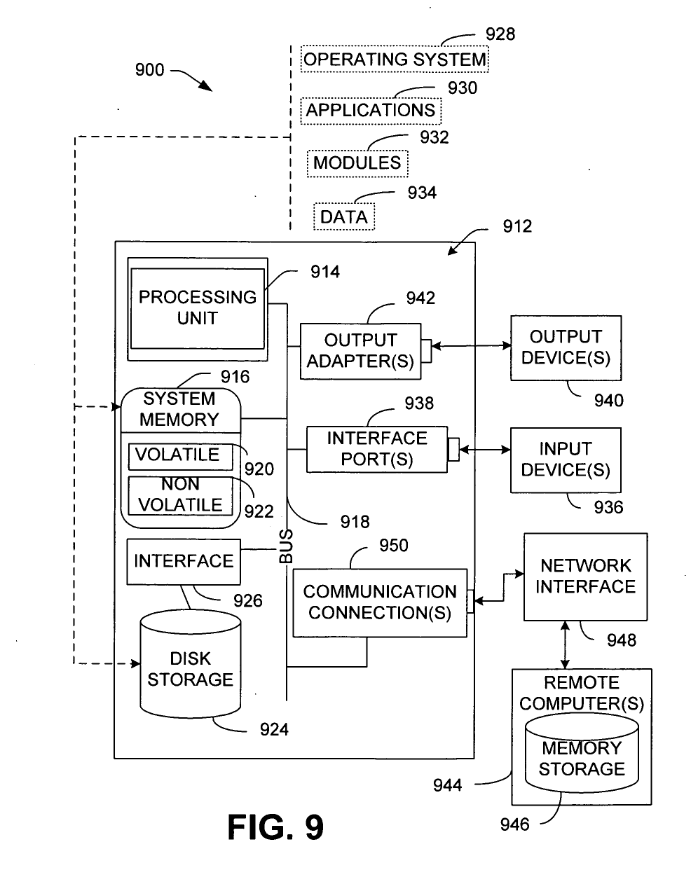

In order to provide additional context for implementing various aspects of the subject invention, FIGS. 8-9 and the following discussion is intended to provide a brief, general description of a suitable computing environment within which various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

FIG. 8 is a schematic block diagram of a sample-computing environment 800 with which the subject invention can interact. The system 800 includes one or more client(s) 810. The client(s) 810 can be hardware and/or software (e.g., threads, processes, computing devices). The system 800 also includes one or more server(s) 820. The server(s) 820 can be hardware and/or software (e.g., threads, processes, computing devices). The servers 820 can house threads or processes to perform transformations by employing the subject invention, for example.

One possible means of communication between a client 810 and a server 820 can be in the form of a data packet adapted to be transmitted between two or more computer processes. The system 800 includes a communication framework 840 that can be employed to facilitate communications between the client(s) 810 and the server(s) 820. The client(s) 810 are operably connected to one or more client data store(s) 850 that can be employed to store information local to the client(s) 810. Similarly, the server(s) 820 are operably connected to one or more server data store(s) 830 that can be employed to store information local to the servers 840.

With reference to FIG. 9, an exemplary environment 900 for implementing various aspects of the invention includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. For example, FIG. 10 illustrates a disk storage 924. The disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in the suitable operating environment 900. Such software includes an operating system 928. The operating system 928, which can be stored on the disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the subject invention can be implemented with various operating systems or combinations of operating systems.

A user enters commands or information into the computer 912 through input device(s) 936. The input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 812 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for identifying testing needs in software development, comprising:
an identification module that associates an attribute of a software component with an identifier that designates a need to test the software component; and
a tracking module that indicates existence of an assigned test for the software component and provides for a user to assign a test for the software component.

2. The system of claim 1, wherein the attribute of the software component is the existence of an error.

3. The system of claim 1, wherein the attribute of the software component is an updated version.

4. The system of claim 1, wherein the tracking module further allows the user to assign at least one test to the software component if at least one test was previously assigned.

5. The system of claim 4, further comprising a notification module that notifies the user of the existence of software components that do not have at least one assigned test.

6. The system of claim 5, further comprising a prioritization module that allows the user to assign a value that indicates a testing priority associated with the software component.

7. The system of claim 6, further comprising a source code change system that allows the user to manage revisions to source code.

8. The system of claim 7, wherein the source code change system includes a versioning component that allows the user to control versions of source code.

9. A method for managing testing of components in software development, comprising:
identifying a software component that is to be subjected to testing and at least one test that is to be performed on the software component; and
tracking a status associated with testing of the software component such that a user can ascertain the tracked status for the identified software component.

10. The method of claim 9, wherein the act of tracking a status associated with testing of the software component includes assigning a substatus.

11. The method of claim 10, wherein the act of tracking a status associated with testing of the software component includes assigning a priority.

12. The method of claim 11, wherein the act of tracking a status associated with testing of the software component includes assigning a difficulty indicator.

13. The method of claim 12, wherein the act of tracking a status associated with testing of the software component includes assigning a milestone.

14. The method of claim 13, wherein the act of tracking a status associated with testing of the software component includes identifying a tester to which testing of the software component may be assigned.

15. A system for managing testing of components in software development, comprising:
means for identifying a software component that is to be subjected to testing and at least one test that is to be performed on the software component; and
means for tracking a status associated with testing of the software component such that a user can ascertain the tracked status for the identified software component.

16. The system of claim 15, wherein the means for tracking a status associated with testing of the software component includes means for assigning a substatus.

17. The system of claim 16, wherein the means for tracking a status associated with testing of the software component includes means for assigning a priority.

18. The system of claim 17, wherein the means for tracking a status associated with testing of the software component includes means for assigning a difficulty indicator.

19. The system of claim 18, wherein the means for tracking a status associated with testing of the software component includes means for assigning a milestone.

20. The system of claim 19, wherein the means for tracking a status associated with testing of the software component includes means for identifying a tester to which testing of the software component may be assigned.
